(19) United States
(12) Patent Application Publication
(10) Pub. No.: US 2022/0190519 A1
(43) Pub. Date: Jun. 16, 2022

(54) ELECTRICAL CONNECTOR FOR A BUS BAR

(71) Applicant: Saint-Augustin Canada Electric Inc., Saint-Augustin-de-Desmaures (CA)

(72) Inventors: Sébastien Arcand, Saint-Augustin-de-Desmaures (CA); Daniel Garneau, Lévis (CA); Félix Houde, Saint-Raymond (CA)

(21) Appl. No.: 17/601,310

(22) PCT Filed: Apr. 2, 2020
(86) PCT No.: PCT/IB2020/053152

§ 371 Date: Oct. 4, 2021

Related U.S. Application Data
(60) Provisional application No. 62/829,726, filed on Apr. 5, 2019.

(51) Int. Cl. H01R 13/627; H01R 13/639; H01R 4/60; H02G 5/06

(52) U.S. Cl. CPC H01R 13/6278; H02G 5/061; H01R 4/60; H01R 13/639

(57) ABSTRACT

An electrical connector for connecting a bus bar to a flexible conductor comprising a tubular conducting body having a first end adapted for lockably receiving an end of the flexible conductor and an opposite second end adapted for mounting a corresponding end of the bus bar therewith. The electrical connector is also provided with at least one resilient element operatively mounted with the second end of the tubular body and the corresponding end of the bus bar for maintaining the bus bar and the tubular body connected together.

### TECHNICAL FIELD

The present invention generally relates to bus bars, and more particularly relates to an electrical connector for connecting a bus bar to a flexible conductor and also relates to a bus bar connector for connecting bus bars together.

### BACKGROUND

In various electrical arrangements, flexible cables are often used for connecting bus bars together. Typically, flexible cables are crimped to make a crimped joint to each extremity and each crimped joint is bolted on a corresponding bus bar extremity.

When the crimped joint is not conveniently crimped and/or not bolted properly to the bus bar, it may prematurely deteriorate and may even result in a fire.

It would therefore be desirable to provide an improved electrical arrangement for connecting a bus bar to a flexible conductor that would reduce the above-mentioned drawback of the prior art.

### SUMMARY

Accordingly, there is provided an electrical connector for connecting a bus bar to a flexible conductor. The electrical connector has a tubular conducting body having a first end adapted for lockably receiving an end of the flexible conductor and a second opposed end adapted for mounting an end of the bus bar therewith. The electrical connector is also provided with one or more resilient elements operatively mounted with the second end of the tubular body and the corresponding end of the bus bar for maintaining the bus bar and the tubular body connected together.

In one embodiment, the bus bar has an elongated bus bar adapter longitudinally attached to the corresponding end of the bus bar.

In one embodiment, the first end of the tubular body is provided with a radial aperture therethrough for receiving a locking element therein. The locking element urges against the end of the flexible conductor for locking up the flexible conductor into the tubular body.

In one embodiment, the electrical connector is further provided with an isolating body for surrounding the tubular conducting body.

In one embodiment, the first end of the tubular body has an inner tubular surface adapted for fittingly receiving the end of the flexible conductor.

In one embodiment, the first end of the tubular body has an outer radial surface defining an abutment surface collaborating with a corresponding radial surface of the end of the flexible conductor for positioning the flexible conductor into the tubular body.

In one embodiment, the second end of the tubular body has an inner tubular surface provided with an inner groove therearound for mounting the resilient element therein, the inner surface being further adapted for fittingly receiving the corresponding end of the bus bar.

In one embodiment, the corresponding end of the bus bar is provided with an inner groove therearound for receiving a portion of the resilient element therein when the bus bar is mounted into the tubular body.

In one embodiment, the inner tubular surface of the second end of the tubular body is provided with a stop flange providing an abutting surface for mounting the corresponding end of the bus bar therewith.

In one embodiment, the corresponding end of the bus bar is provided with a beveled edge.

In one embodiment, the resilient element comprises an elastic ring.

According to a further aspect, in one embodiment, the corresponding end of the bus bar is provided with an inner connecting bore. The electrical connector further has a conducting connecting pin having a mounting body mounted to the second end of the tubular conducting body. The connecting pin projects outwards the conducting body for fitting insertion into the connecting bore of the bus bar. The connecting pin further has a slot adapted for receiving the resilient element therein.

In one embodiment, the second end of the tubular body has an inner tubular surface adapted for fittingly receiving the mounting body of the connecting pin.

In one embodiment, the inner tubular surface of the second end of the tubular body is provided with a stop flange providing an abutting surface for mounting the mounting body of the connecting pin.

In one embodiment, the inner tubular surface of the second end of the tubular body is provided with a flat surface. The mounting body of the connecting pin has a corresponding flat surface cooperating with the flat surface of the second end of the tubular body for preventing rotation of the connecting pin inside the tubular body.

In one embodiment, the mounting body of the connecting pin has a longitudinal projecting element projecting towards the first end of the conducting body. The end of the flexible conductor is securable against the longitudinal projecting element of the connecting pin.

In one embodiment, the mounting body has a radial end surface adapted for mounting the end of the flexible conductor thereagainst.

According to still a further aspect, there is also provided a bus bar connector for connecting a first and a second bus bars together. The bus bar connector has a first and a second electrical connectors as previously described, the first and second electrical connectors being connected together through the flexible conductor.

### BRIEF DESCRIPTION OF THE DRAWINGS

In order that the invention may be readily understood, embodiments of the invention are illustrated by way of example in the accompanying drawings.

FIG. 1 is a perspective elevated view of an electrical arrangement showing a first set and a second set of electrical connectors for a bus bar, according to one embodiment;

FIG. 2 is a partially exploded perspective view of the first set of electrical connectors shown in FIG. 1;

FIG. 3 is a cross sectional side view of an electrical connector of the first set shown in FIG. 1;

FIG. 4 is another cross sectional side view of the electrical connector of the first set shown in FIG. 3, partially exploded;

FIG. 5 is a perspective view of an elongated bus bar adapter of the electrical connector shown in FIG. 3;

FIG. 6 is a cross sectional perspective view of a conducting tubular body of the electrical connector shown in FIG. 3;

FIG. 7 is a partially exploded perspective elevated view of the second set of electrical connectors shown in FIG. 1;

FIG. 8 is a cross sectional side view of an electrical connector of the second set shown in FIG. 1;

FIG. 9 is another cross sectional side view of the electrical connector of the second set shown in FIG. 8, partially exploded;

FIG. 10 is a cross sectional perspective view of a conducting tubular body of the electrical connector shown in FIG. 8;

FIG. 11 is an elevated perspective view of a connecting pin of the electrical connector shown in FIG. 8.

Further details of the invention and its advantages will be apparent from the detailed description included below.

### DETAILED DESCRIPTION

In the following description of the embodiments, references to the accompanying drawings are by way of illustration of examples by which the invention may be practiced. It will be understood that other embodiments may be made without departing from the scope of the invention disclosed.

The present electrical connector is particularly devised to provide an easy to install and reliable electrical connection between a rigid bus bar and a flexible conductor. Two electrical connectors connected together through a flexible conductor may also be used to provide a bus bar connector for connecting a first and a second bus bars together, as detailed below.

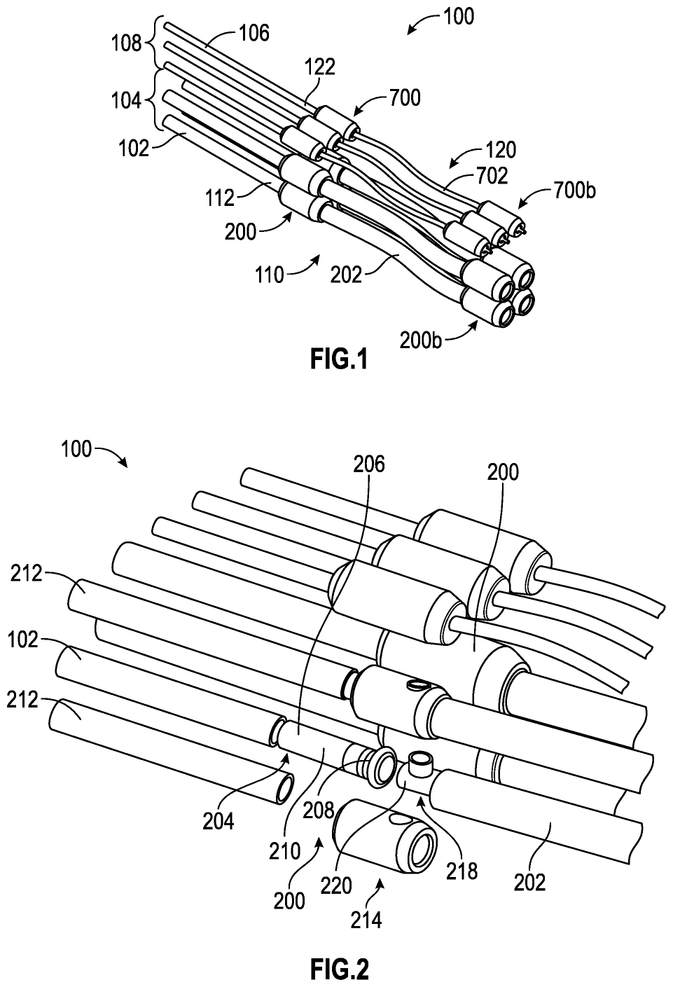

Referring to FIG. 1, there is shown an electrical arrangement 100 provided with four rigid tubular conductors, also called bus bars 102, arranged in a square configuration and defining a first set 104 of bus bars 102 and three rigid tubular conductors 106, also called bus bars 106, arranged in a linear configuration and defining a second set 108 of bus bars 106. In the illustrated embodiment, the bus bars 102 of the first set 104 are 400V conductors while the bus bars 106 of the second set 108 are 120V conductors of a smaller diameter. Other arrangements may be considered, as it will become apparent below.

Each of the rigid tubular bus bars 102 of the first set 104 is connected to a respective bus bar connector 110. The bus bar connector 110 has a first electrical connector 200 connected to an end 112 of the corresponding rigid tubular conductor 102 and a flexible conductor 202 connected thereto, as it will be detailed below. The bus bar connector 110 also has a second electrical connector 200b connected to the first electrical connector 200 through the flexible conductor 202. In one embodiment, the second electrical connector 200b is similar to the first electrical connector 200 and is adapted to be connectable to another bus bar (not shown). Each of the bus bars 106 of the second set 108 is connected to a respective bus bar connector 120. The bus bar connector 120 has a first electrical connector 700 connected to an end 122 of the corresponding bus bar 106 and a flexible conductor 702 connected thereto. The bus bar connector 120 also has a second electrical connector 700b connected to the first electrical connector 700 through the flexible conductor 702. In one embodiment, the second electrical connector 702b is similar to the first electrical connector 702 and is adapted to be connectable to another bus bar (not shown).

Referring to FIGS. 2 to 4, an electrical connector 200 for connecting a bus bar 102 of the first set 104 shown in FIG. 1 to a flexible conductor 202 will now be described, according to one embodiment. The electrical connector 200 has an elongated bus bar adapter 204 having a first end 206 connectable to the bus bar 102 and a second opposed end 208. In the illustrated embodiment, the bus bar adapter 204 has an elongated tubular bar 210 that is mounted coaxially to the bus bar 102 and in electrical contact. A tubular insulating sheath 212 is mounted around the bus bar 102 and the elongated tubular bar 210 of the bus bar adapter 204 to maintain them together and for electrical isolation. In one embodiment, the elongated tubular bar 210 is welded to the corresponding end of the bus bar 102. In a further embodiment, the elongated tubular bar 210 is silver plated to enhance the electrical connection. In an alternative embodiment, the elongated bus bar adapter 204 is integral to the bus bar 102, as it will become apparent below.

Referring to FIGS. 2 to 4, and also to FIG. 6, the electrical connector 200 also has a tubular conducting body 214 having a first end 216 adapted for lockably receiving an end 218 of the flexible conductor 202 therein. In the illustrated embodiment, the end 218 of the flexible conductor 202 has a portion 220 of reduced diameter which define a radial surface 222 between the portion 220 of reduced diameter and the remaining portion of the flexible conductor 202. The first end 216 of the tubular conducting body 214 has an inner tubular surface 224 adapted for fittingly receiving the reduced diameter portion 220 of the flexible conductor 202 therein. Moreover, in one embodiment, the first end 216 of the tubular conducting body 214 has an outer radial surface 226 defining an abutment surface collaborating with the radial surface 222 provided at the end 218 of the flexible conductor 202 for positioning the flexible conductor 202 into the tubular conducting body 214. In one embodiment, the inner diameter of the first end 216 of the tubular conducting body 214 is very slightly greater than the diameter of the portion 220 of reduced diameter of the flexible conductor 202. In a further embodiment, the inner edge 228 of the outer radial surface 226 is beveled to ease insertion of the portion 220 of the flexible conductor 202 inside the first end 216 of the conducting body 214. In an alternative embodiment, the inner tubular surface 224 may be provided with a stop flange (not shown) providing an abutting surface for mounting the end 218 of the flexible conductor 202 into the first end 216 of the conducting body 214.

In one embodiment, the tubular conducting body 214 may be made of any adequate electrically conducting material such as copper or aluminum.

In one embodiment, the first end 216 of the tubular conducting body 214 is also provided with a radial aperture 230 therethrough for receiving a locking element 232 therein. The locking element 232 urges against the reduced diameter portion 220 of the flexible conductor 202 for locking the flexible conductor 202 into the tubular body 214. The locking element 232 may be a threaded headless screw as a non-limiting example. As it should now be apparent, the flexible conductor 202 may be easily and reliably secured into the conducting body 214. If required, the flexible connector 202 can also be easily removed and replaced. This proposed arrangement is also of great advantage since it enables an enlarged electrical contact between the reduced diameter portion 220 of the flexible conductor 202 and the conducting body 214.

The tubular conducting body 214 of the electrical connector 200 also has a second end 234 opposed to the first end 216 and adapted for mounting the second end 208 of the bus bar adapter 204 therewith. In one embodiment, the second end 234 of the tubular conducting body 214 has an inner tubular surface 236 adapted for fittingly receiving the second end 208 of the bus bar adapter 204, as it will become apparent below. In one embodiment, the inner diameter of the second end 234 of the tubular conducting body 214 is very slightly larger than the diameter of the bus bar adapter 204.

The electrical connector 200 is also provided with a resilient element 238 operatively mounted with the second end 234 of the tubular conducting body 214 and the second end 208 of the bus bar adapter 204 for maintaining the bus bar adapter 204 and the tubular conducting body 214 connected together. It is to be understood that the electrical connector 200 could be provided with more than one resilient element 238, radially spaced and providing similar function.

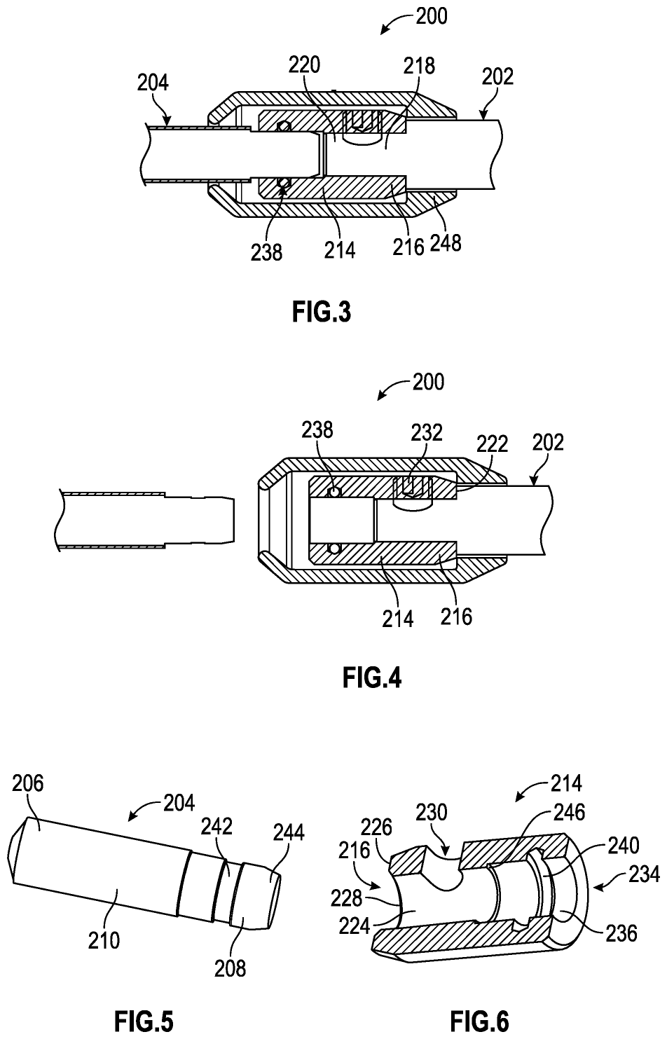

In one embodiment, the inner tubular surface 236 of the second end 234 of the tubular body 214 is provided with an inner annular groove 240 therearound for mounting the resilient element 238 therein, for example, an elastic ring. The second end 208 of the bus bar adapter 204 is also provided with an outer annular groove 242 therearound for receiving a portion of the resilient element 238 therein when the bus bar adapter 204 is mounted into the tubular body 214, as better shown in FIG. 3. For mounting the electrical connector 200, the second end 208 of the bus bar adapter 204 is inserted into the second end 234 of the tubular body 214 until the outer annular groove 242 around the second end 208 of the bus bar adapter 204 is substantially aligned with the inner annular groove 240 of the inner tubular surface 236 of the second end 234 of the tubular body 214. The resilient element 238 extends into the two annular grooves 240, 242 and urges against the outer surface of the bus bar adapter 204 to maintain it in place in the conducting body 214, even in harsh vibrating environment for example. With this arrangement, the outer surface of the bus bar adapter 204 is in electrical contact substantially all around with the inner tubular surface 236 of the second end 234 of the tubular body 214 to thereby enable an electrical connection between the bus bar 102 electrically connected to the bus bar adapter 204 and the flexible conductor 202 electrically connected to the conducting body 214.

In order to ease insertion of the bus bar adapter 204 into the second end 234 of the conducting body 214, in one embodiment, the second end 208 of the bus bar adapter 204 is provided with a beveled edge 244. In a further embodiment, the second end 234 of the tubular conducting body 214 also has a beveled edge (not shown) to further ease the insertion.

In still a further embodiment, the inner tubular surface 236 of the second end 234 of the tubular body 214 is further provided with a stop flange 246 providing an abutting surface for mounting the second end 208 of the bus bar adapter 204 therewith. In other words, when the bus bar adapter 204 is mounted into the second end 234 of the tubular body 214, the second end 208 of the bus bar adapter 204 extends against the abutting surface while the two annular grooves 240, 242 extend in a facing relationship, as better shown in FIG. 2.

In one embodiment, the resilient element 238 is adapted to firmly retain the bus bar adapter 204 into the conducting body 214 once mounted together, but should also allow removal of the bus bar adapter 204 if required in a given application.

Referring again to FIGS. 2 to 4, in a further embodiment, the electrical connector 200 is further provided with an isolating body 248 for surrounding the tubular conducting body 214 and providing electrical isolation, as well known in the art.

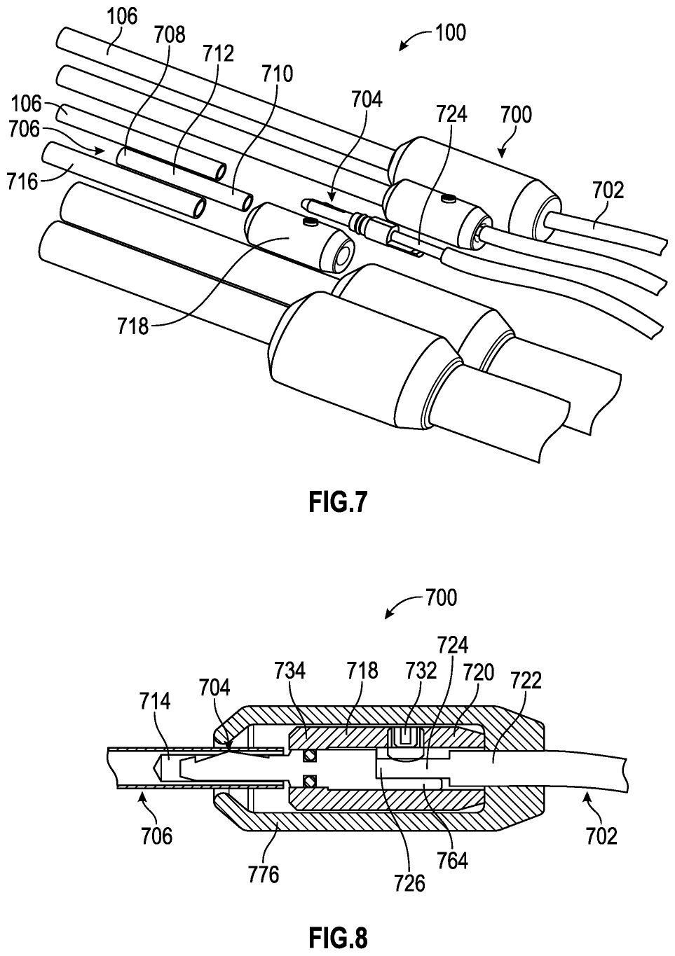

Reference is now made to FIGS. 7 to 9 showing an electrical connector 700 for connecting a bus bar 106 of the second set 108 shown in FIG. 1 to a flexible conductor 702, according to one embodiment. As it will be detailed below, the electrical connector 700 is provided with a connecting pin 704 for connecting the electrical connector 700 to the bus bar 106.

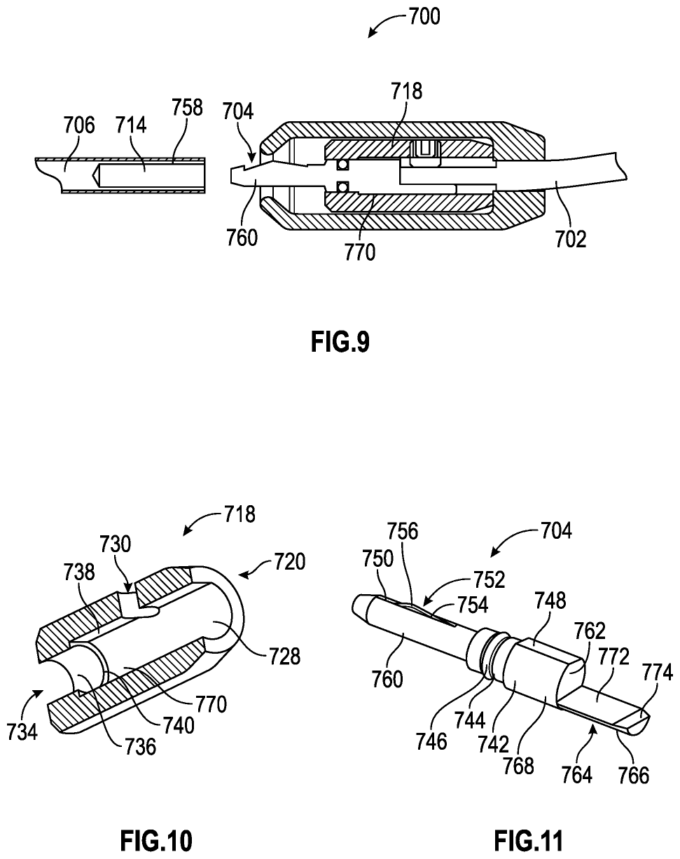

The electrical connector 700 has an elongated bus bar adapter 706 having a first end 708 connectable to the bus bar 106 and a second opposed end 710. In the illustrated embodiment, the bus bar adapter 706 has an elongated tubular bar 712 that is mounted coaxially to the bus bar 106 and in electrical contact. The second end 710 of the bus bar adapter 706 is further provided with an inner connecting bore 714, as better shown in FIG. 9. A tubular insulating sheath 716 is mounted around the bus bar 106 and the elongated tubular bar 712 of the bus bar adapter 706 to maintain them together and for electrical isolation. In one embodiment, the elongated bus bar adapter 706 is welded to the corresponding end of the bus bar 106. In a further embodiment, the elongated bus bar adapter 706 and its inner connecting bore 714 are silver plated to enhance the electrical connection. In an alternative embodiment, the elongated bus bar adapter 706 is integral to the bus bar 106.

Referring to FIGS. 7 to 9, and also to FIG. 10, the electrical connector 700 also has a tubular conducting body 718 having a first end 720 adapted for lockably receiving an end 722 of the flexible conductor 702 therein. In the illustrated embodiment, the end 722 of the flexible conductor 702 has a reduced diameter portion 724 ending with a radial surface 726 that is used for electrical connection, as detailed below. The first end 720 of the tubular conducting body 718 has an inner tubular surface 728 adapted for receiving the reduced diameter portion 724 of the flexible conductor 702 therein, as detailed below.

In one embodiment, the first end 720 of the tubular conducting body 718 is also provided with a radial aperture 730 therethrough for receiving a locking element 732 therein. The locking element 732 urges against the reduced diameter portion 724 of the flexible conductor 702 for locking the flexible conductor 702 into the tubular conducting body 718. The locking element 732 may be a threaded headless screw for a non-limiting example. The flexible conductor 702 may be easily and reliably secured to the conducting body 718, as detailed below. If required for a given application, the flexible connector 702 can also be easily removed and replaced.

The tubular conducting body 718 of the electrical connector 700 also has a second end 734 opposed to the first end 720 and adapted for operatively mounting the second end 710 of the bus bar adapter 706 therewith through a connecting pin 704 insertable into the inner connecting bore 714 of the second end 710 of the bus bar adapter 706, as it will become apparent below. The second end 734 of the tubular conducting body 718 has an inner tubular surface 736 adapted for mounting the connecting pin 704. As better shown in FIG. 10, in one embodiment, the inner tubular surface 736 of the second end 734 of the tubular conducting body 718 is provided with a flat longitudinal surface 738 extending up to the first end 720 of the tubular conducting body 718 to ease the mounting of the connecting pin 704 therein, as described below. The flat longitudinal surface 738 extends into the conducting body 718 so that the radial aperture 730 opens through the flat longitudinal surface 738. In a further embodiment, the inner tubular surface 736 of the second end 734 of the tubular conducting body 718 is further provided with a stop flange 740 providing an abutting surface for mounting the connecting pin 704, as described below. In such embodiment, the flat longitudinal surface 738 extends from the stop flange 740 to the first end 720 of the tubular conducting body 718.

Referring again to FIGS. 7 to 9, and also to FIG. 11, in this illustrated embodiment, as previously mentioned, the electrical connector 700 is further provided with a conducting connecting pin 704 having a mounting body 742 fittingly mountable to the second end 734 of the tubular conducting body 718. In one embodiment, the mounting body 742 is provided with an annular recess 744 therearound to receive a resilient ring 746 therein. This arrangement helps to retain the connecting pin 704 in position in the tubular conducting body 718. Once mounted into the tubular conducting body 718, the connecting pin 704 projects outwards from the conducting body 718 for fitting insertion into the connecting bore 714 of the bus bar adapter 704, as better shown in FIG. 8. In one embodiment, the mounting body 742 of the connecting pin 704 has an outer longitudinal flat surface 748 adapted for cooperating with the corresponding flat longitudinal surface 738 provided on the inner tubular surface 736 of the second end 734 of the tubular conducting body 718 for preventing rotation of the connecting pin 704 inside the tubular conducting body 718. As better shown in FIG. 11, in one embodiment, the connecting pin 704 further has a longitudinal slot 750 extending therein, as detailed thereinafter.

Still referring to FIGS. 7 to 9 and 11, the electrical connector 700 is also provided with a resilient element 752 operatively mounted with the connecting pin 704 for maintaining the bus bar adapter 706, into which the connecting pin 704 is inserted, and the tubular conducting body 718 connected together. In one embodiment, the resilient element 752 is a resilient rod 754 inserted into the longitudinal slot 750 of the connecting pin 704 which acts as a spring. More particularly, in one embodiment, as better shown in FIG. 11, the resilient rod 754 is inserted in compression into the longitudinal slot 750 of the connecting pin 704 and has at least two flexible portions forming an apex 756, the apex 756 projecting outwards from the longitudinal slot 750 of the connecting pin 704. As it should be apparent, when the connecting pin 704 is inserted into the inner connecting bore 714 of the second end 710 of the bus bar adapter 706, the resilient rod 754, more particularly the apex 756 thereof, urges against the facing surface 758 of the inner connecting bore 714. This arrangement enables to retain the connecting pin 704 and the bus bar adapter 706 mechanically connected together. Moreover, the urging force exerted by the resilient rod 754 against the facing surface 758 of the inner connecting bore 714 helps to maintain a radially opposed surface 760 of the connecting pin 704 in electrical contact with the bus bar adapter 706. This arrangement provides an electrical contact all along the length of the connecting pin 704 and is then particularly suitable for use in harsh vibrating environments or in cold temperature environments since the surfaces providing the electrical contact therebetween are firmly urged one against the other.

In a further embodiment, as better shown in FIG. 11, the mounting body 742 of the connecting pin 704 has a radial end surface 762 opposite to the connecting pin 704. The mounting body 742 is further provided with a longitudinal projecting element 764 projecting from the radial end surface 762 towards the first end 720 of the conducting body 718 when the connecting pin 704 is mounted therein. In the illustrated embodiment, the projecting element 764 is off centered with respect to the conducting pin 704 and the mounting body 742 and has a semi circular cross section. More particularly, the projecting element 764 has an outer semi circular surface 766 substantially in the lengthiness of the outer surface 768 of the mounting body 742 and adapted for contacting a corresponding portion 770 of the inner tubular surface 728 of the first end 720 of the conducting body 718 when the connecting pin 704 is mounted into the conducting body 718. The projecting element 764 also has a flat surface 772 opposed to the outer semi circular surface 766 thereof. In one embodiment, the flat surface 772 of the projecting element 764 is parallel to the outer longitudinal flat surface 748 of the mounting body 742 and perpendicular to the radial aperture 730 of the tubular conducting body 718 when the connecting pin 704 is mounted therein. In another embodiment, the projecting element 764 of the connecting pin 704 is radially opposed to the longitudinal slot 750. In a further embodiment, the flat surface 772 of the projecting element 764 ends longitudinally with a beveled edge 774.

Referring again to FIGS. 8 and 9, the longitudinal projecting element 764 of the mounting body 742 of the connecting pin 704 is used to retain the end 722 of the flexible conductor 702 into the conducting body 718. More specifically, when the electrical connector 700 is mounted to the flexible conductor 702, the conducting pin 704 is first inserted into the second end 734 of the conducting body 718 through the first end 720 thereof. The end 722 of the flexible conductor 702 is then inserted into the first end 720 of the tubular body 718, between the flat surface 772 of the projecting element 764 and a portion of the inner tubular surface 728 of the first end 720 of the conducting body 718 facing the flat surface 772. In one embodiment, the flexible conductor 702 is inserted into the tubular body 718 so that the radial surface 726 of the end 722 of the flexible conductor 702 contacts the radial end surface 762 of the mounting body 742 of the connecting pin 704. At this point, the end 722 of the flexible conductor 702 can be secured in place against the longitudinal projecting element 764 of the connecting pin 704 with the locking element 732 extending through the radial aperture 730 of the first end 720 of the conducting body 718.

As it should now be apparent, the flat surfaces 748 of the mounting body 742 and the flat surface 738 of the tubular conducting body 718 help to guide the connecting pin 704 in a predetermined orientation into the conducting body 718. The stop flange 740 defines the longitudinal position of the connecting pin 704 into the conducting body 718. Once the end 722 of the flexible conductor 702 abuts against the radial end surface 762 of the mounting body 742 of the connecting pin 704 and is radially secured with the locking element 732, it also provides an additional force sufficient for preventing the connecting pin 704 to move from its position even if an undesired force is applied against the projecting end of the connecting pin 704. The flat surfaces 748, 738 guiding the connecting pin 704 inside the conducting body 718 also ensure that the flat surface 772 of the projecting element 764 of the connecting pin 704 is oriented radially with respect to the locking element 732 so that the end 722 of the flexible conductor 702 is appropriately sandwiched. The skilled addressee will appreciate that the present arrangement also provides an enlarged surface for the electrical connection between the flexible conductor 702 and the connecting pin 704. The connection of the connecting pin 704 with the bus bar adapter 706, as already mentioned, also provides an enlarged electrical connection surface, to thereby provide an electrical connector 700 that is very reliable, even in harsh environments.

In a further embodiment, the electrical connector 700 is further provided with an isolating body 776 for surrounding the tubular conducting body 718 and providing electrical isolation, as well known in the art.

Reference is made again to FIG. 1 previously described. As it should now be apparent, the electrical conductors 200 and 700 previously described are particularly well suited for any applications requiring connecting a bus bar to a flexible conductor in a reliable and easy manner even in harsh environments. In a further embodiment, a pair of first and second connectors connected together through a flexible conductor define a bus bar connector for connecting a first and a second bus bars together. Such arrangement may be of great advantage for use in specific applications requiring to use several bus bars longitudinally operatively connected to convey electric power on long distances. For example, in tall wind turbines, electric power produced in the nacelle on the top of the pole should be conveyed to the bottom of the pole, typically with rigid bus bars that are subjected to movements and vibrations of large amplitude. Typically, the first and second electrical connectors of the bus bar connector are identical for connecting two identical bus bars together. However, in an alternative embodiment, it could also be considered to use the bus bar connector as a bus bar adapter for connecting two bus bars of different diameter together.

Although the above description relates to specific preferred embodiments as presently contemplated by the inventors, it will be understood that the invention in its broad aspect includes mechanical and functional equivalents of the elements described herein.

1. An electrical connector for connecting a bus bar to a flexible conductor, said electrical connector comprising:
a tubular conducting body having a first end adapted for lockably receiving an end of the flexible conductor and an opposite second end adapted for mounting a corresponding end of the bus bar therewith; and
at least one resilient element operatively mounted with the second end of the tubular conducting body and the corresponding end of the bus bar for maintaining the bus bar and the tubular conducting body connected together.

2. The electrical connector of claim 1, wherein the bus bar comprises an elongated bus bar adapter longitudinally attached to the corresponding end of the bus bar.

3. The electrical connector of claim 1, wherein the first end of the tubular conducting body is provided with a radial aperture therethrough for receiving a locking element therein, the locking element urging against the end of the flexible conductor for locking the flexible conductor into the tubular conducting body.

4. The electrical connector of claim 1, further comprising an isolating body for surrounding the tubular conducting body.

5. The electrical connector of claim 1, wherein the first end of the tubular conducting body has an inner tubular surface adapted for fittingly receiving the end of the flexible conductor.

6. The electrical connector of claim 1, wherein the first end of the tubular conducting body has an outer radial surface defining an abutment surface collaborating with a corresponding radial surface of the end of the flexible conductor for positioning the flexible conductor into the tubular conducting body.

7. The electrical connector of claim 1, wherein the second end of the tubular conducting body has an inner tubular surface provided with an inner groove therearound for mounting the resilient element(s) therein, the inner tubular surface being further adapted for fittingly receiving the corresponding end of the bus bar.

8. The electrical connector of claim 1, wherein the corresponding end of the bus bar is provided with an inner groove(s) therearound each being correspondingly shaped and sized for receiving a portion of the resilient element(s) therein when the bus bar is mounted into the tubular conducting body.

9. The electrical connector of claim 7, wherein the inner tubular surface of the second end of the tubular conducting body is provided with a stop flange providing an abutting surface for mounting the corresponding end of the bus bar therewith.

10. The electrical connector of claim 1, wherein the corresponding end of the bus bar is provided with a beveled edge.

11. The electrical connector of claim 1, wherein the resilient element(s) comprises an elastic ring.

12. The electrical connector of claim 1, wherein the corresponding end of the bus bar is provided with an inner connecting bore, the electrical connector further comprising a conducting connecting pin having a mounting body mounted to the second end of the tubular conducting body, the connecting pin projecting outwards from the tubular conducting body for fitting insertion into the inner connecting bore of the bus bar, the connecting pin further having a slot adapted for receiving the resilient element therein.

13. The electrical connector of claim 12, wherein the second end of the tubular conducting body has an inner tubular surface adapted for fittingly receiving the mounting body of the connecting pin.

14. The electrical connector of claim 13, wherein the inner tubular surface of the second end of the tubular conducting body is provided with a stop flange providing an abutting surface for mounting the mounting body of the connecting pin.

15. The electrical connector of claim 12, wherein the inner tubular surface of the second end of the tubular conducting body is provided with a flat surface, the mounting body of the connecting pin having a corresponding flat surface cooperating with the flat surface of the second end of the tubular conducting body for preventing rotation of the connecting pin inside the tubular conducting body.

16. The electrical connector of claim 12, wherein the mounting body of the connecting pin comprises a longitudinal projecting element projecting towards the first end of the tubular conducting body, the end of the flexible conductor being securable against the longitudinal projecting element of the connecting pin.

17. The electrical connector of claim 12, wherein the mounting body has a radial end surface adapted for mounting the end of the flexible conductor thereagainst.

18. A bus bar connector for connecting a first bus bar and a second bus bar together, said bus bar connector comprising a first of the electrical connector and a second of the electrical connector as defined in claim 1, said first and second electrical connectors being connected together through the flexible conductor.
